(19) United States
(12) Patent Application Publication
(10) Pub. No.: US 2015/0225052 A1
(43) Pub. Date: Aug. 13, 2015

(54) Method and Apparatus for Precision Tracking of Approaching Magnetic-Detonated and Traditional Impact Torpedoes

(71) Applicant: Steve Cordell, Vancouver, WA (US)

(72) Inventor: Steve Cordell, Vancouver, WA (US)

(21) Appl. No.: 13/940,755

(22) Filed: Jul. 12, 2013

Related U.S. Application Data
(60) Provisional application No. 61/741,317, filed on Jul. 17, 2012.

(51) Int. Cl. B63G 9/02; G06N 5/04; G05B 15/02; G01S 15/88; G01S 19/13

(52) U.S. Cl. CPC B63G 9/02; G01S 15/88; G01S 19/13; G05B 15/02; G06N 5/04; B63G 2009/005

(57) ABSTRACT

Capturing or impeding traditional or supercavitating torpedoes from striking a side or entering the keel area of a capital ship depends on very precise tracking. Because supercavitating torpedoes travel at about 550 miles/hr, even milliseconds will be vital, perhaps causing a countermeasure weapon, like a supercavitating cannon shell, to disrupt its cavitation but not impeding its slower motion toward the ship. Likewise, capture curtain soft-kill defense allows not one second to be squandered because of inaccurate tracking. One purpose of the invention is to scatter, in and around the roughly calculated path of the torpedo, tiny, inexpensive balls that have sonar, magnetometers and other active and passive sensors to aid Fire Control predicting arrival time and where it will strike. Over time, smaller swarms of measurement balls are continually launched as tracking precision improves. Countermeasures are constantly updated by Fire Control.

A second use aids a helicopter that acquired a super quiet submarine; it can initially launch a wide swarm of sensors in the sub's area, and they will continually monitor the movement. As location becomes more precise, smaller swarms are launched in sequence. If the sub dives for safe layers, the swarm detaches the sonar ball and they will sink slowly, using sonar and sending location pinging messages to Fire Control.

### FIELD OF THE INVENTION

The invention concerns a method and apparatus for precisely tracking an incoming traditional or supercavitating torpedo, or a salvo, so that it/they can be captured, slowed, turned, and stopped or otherwise neutralized to protect a targeted ship.

### BACKGROUND OF THE PRIOR ART AND THE CURRENT STATE OF SHIP PROTECTION

At this time, a capital ship cannot outrun a torpedo nor does it have the time to maneuver itself out of its path. Given enough warning that a torpedo is on an impact track, there are some measures that a modern aircraft carrier could use to save itself from destruction. However, the luxury of a sufficient warning does not exist.

Using the assumption estimated by the Navy that there would be only 9 seconds of warning, I have published one method of stopping a supercavitating torpedo¹, submitted another for publication², and have a U.S. patent pending³ for yet another method of protecting capital ships against supercavitating torpedoes, singly or in salvos. The patent application describes a method and apparatus for capturing an incoming torpedo with a capture curtain at a distance from the ship. It describes how the curtain is extended below the keel to capture a torpedo that has not been preset to hit the ship above the keel.

### THE PROBLEM TO BE SOLVED

Allied aircraft carriers of the current and previous generations are threatened by a new generation of torpedoes that can be delivered by silent, conventional submarines as well as by the larger nuclear subs, launched by smaller ships or other gunboats, delivered by aircraft, by missile, or as part of a missile. The torpedoes of main concern are those that are not aiming for the sides of ships, but which are aiming to explode when they are directly under the keel of ships, thus tending to break their backs, so to speak, and tearing them into two parts that sink almost instantly. The damage is great no matter under which part of the ship the torpedo explodes.

To capture magnetic-detonated torpedoes before they reach the ship, they must be precisely tracked during the critical seconds of their approach. Gross tracking is a simple process after knowing that the ship is the target. Difficult is knowing precisely where the torpedo is so that timely countermeasures can be taken; for example, at 550 mph, a capture curtain or supercavitating countermeasures and the Fire Control system will only have milliseconds to react and execute^{1,3}. With precise tracking, this time can be increased to a precious few seconds.

To detect and track conventional quiet submarines, a method is specified that will continuously keep the sub's location calculated. At this time, test submarines are being used with helicopter and dipping sonar, but the submarines are proving that they can escape after detection.

### SUMMARY AND OBJECTS OF THE INVENTION

### Summary of the Method and Apparatus

Nomenclature used: Monitor Marbles are apparatus used to gather precise data from incoming torpedoes close to the targeted ship. Sentinel Marbles are apparatus used to gather location at any instant, motion, and signature data from incoming torpedoes further away from the ship. Fire Control is a communication center, a control center for executing torpedo countermeasures, and it also controls and transmits data between itself and the Monitor and Sentinel Marbles, among execution of other tasks.

Since the ship knows that it is the target as soon as the torpedo accelerates for its attack, the torpedo can be roughly tracked by own-ship sonar and by sonars of other ships in the task force. There is no time for helicopter search via dipping sonar, and accompanying submarines can neither safely nor rapidly enough warn the aircraft carrier with tracking information. The proposed method is to track the final seconds of the torpedo precisely by using a swarm of sensors that have been scattered around the target ship, and that will be continuously scattered around it until there is no further danger. Fire Control will know how to scatter the sensors, whether scattered to a sector of just a few degrees or even if a 360 degree scattering is necessary. The Monitor and Sentinel Marbles have the following characteristics (FIGS. 1 and 2, respectively): 1) Inexpensive, since they might be scattered by the thousands in an emergency or during drills; 2) Tiny, so that many can be stored at the ready and can be rapidly scattered; 3) Very low-powered self-destruction after less than a minute and sinking all marbles, so their stored signatures will not be compromised and they can never be capable of false-alarm warnings in the future; 4) Intelligent Logic, so they can quickly and accurately make measurements about the incoming torpedoes and report time, location and highpoints such as peak sound or noise; 5) Sensors, so magnetic detection and sound can be tracked over time, and a static GPS will be available; 6) Magnetometers within the integrated circuitry will also aid in tracking torpedoes, especially advantageous for those marbles directly over the torpedo path; 7) Reporting, using an own number, GPS Location, and its data already processed by its own Central Processing Unit (CPU); 8) Signal receiving, so that Fire Control can request additional information from only those marbles in a certain area of the marble swarm; 9) Battery, with long shelf-life but only powerful enough to complete the duty time in seconds; 10) Radio communication between Monitor Marbles via multi-channel transceiver and its antenna; 11) The antenna is tuned for low-power transmissions to Fire Control; 12) Underwater communication with other Monitor Marbles in the face of torpedo noise will be possible in the future by adding transceiver features to the sonar systems

When the knowledge arrives that the ship is the target, and the rough path to impact becomes known, special Sentinel Marbles are shot into the waters in the approximate path and as far from the ship as possible. These marbles are themselves noiseless, so they are ideally fit to capture the torpedo's noise signatures that they do not associate with location but with depth and sound level: Fire Control then converts the data into distance, depth and speed. This signature data is both entered into the Monitor Marbles even as they are being readied for scattering on the launcher, and then later transferred to them on the water as updates to their firmware. If the preferred method of launching Sentinel Marbles as a swarm cannot be executed due to wind, weather, or for other reasons, then an always-at-the-ready set of marbles in a suitable container can be launched; the swarm will then be widely released over the targeted area.

### DESCRIPTION OF THE METHOD

Tracking via sound level and magnetic data, with location and an accurate timestamp are the most important information that is constantly transmitted from the Monitor and Sentinel Marbles to Fire Control. Fire Control effectively triangulates constantly to pinpoint the exact location of the torpedo with a timestamp and the location where and when it will strike the ship or cross its keel. It is understood that the word triangulation is an old-fashioned method, but the concept is valid even if the algorithms used by Fire Control are as complex as the amount of data that is constantly transmitted to it. The time of arrival and either the point of impact or the location of its keel crossing is transmitted to the torpedo countermeasures (refer to Objects of the Invention).

The Monitor Marbles are launched as a swarm closer to the ship than the Sentinel Marbles. The most important feature is that the Monitor Marbles are not too close to the ship; they are far enough away in location and in time that countermeasures against conventional torpedoes and even supercavitating torpedoes can be executed. It is vital that all torpedoes on track to explode under the keel can be stopped. The Capture Curtain method¹ has not been proven, and supercavitating countermeasures can only be considered secure enough when a method and apparatus can precisely determine the arrival time and the location.

Description of the Apparatus:

Only known, proven technology that is simple but can be used to manufacture all equipment inexpensively will be applied to the final Monitor and Sentinel Marbles. Independent of the apparatus used, in all cases there will be a swarm of marbles to ensure that the expected torpedo discovery, monitoring and communication about its findings will be transmitted to Fire Control.

Construction of the Monitor and Sentinel Marbles:

The Monitor Marbles (FIG. 1) and Sentinel Marbles (FIG. 2) have the same size, about 1.25 inches outside diameter. The round casings are thin unbreakable plastic, round and smooth for greater safety in transport, when stored in deep, irregular-shaped bins, and when they are poured out of the bins into the launcher, they will roll out smoothly and will take up ready-positions to fill the launcher. In particular, they will leave the launcher smoothly as only slick balls can! The battery shown in FIG. 1 is quite small, since the active life of the marble is a few seconds until it self-destructs. The battery for the Sentinel Marble is larger to allow long transmission bursts of raw torpedo data over a longer distance to Fire Control. The floatable Sentinel Marbles are quite heavy by design to increase their mass for their extended travel after leaving their special launchers. They do not self-destruct, but at the end of their task, instead they erase and scrub their memories. All antennas are telescoping and they extend automatically after hitting the water; this can be accomplished by sensor-executed electronics or less reliably electrically by water contact.

### Algorithms

### AN EXAMPLE

Monitor Marbles all transmit a number of data values from a variety of its sensors to Fire Control. Sonar in a Monitor Marble directly over the torpedo begins pinging before the torpedo arrives, and there are no returns. The torpedo arrives and pinging finally causes a return; later it reaches the end of torpedo, and pinging brings no more returns. The marble only calculates sparsely; it sends the raw data for the torpedo length to Fire Control. Since Fire Control knows from the Sentinel Marble swarm the approximate path of the torpedo, it gives Monitor Marble #n the honor of pinging the torpedo that will pass directly under it. Other marbles get the chance to also ping, but they will be at some other right and left location, asymmetrically spaced so that when marble to the right pings, it can be roughly calculated as its own, and not transmitted by top or left marble. This could be expanded to five or even more marbles given the task of sonar pinging. This thus offers at least three different readings for the torpedo length and thus a quite precise speed value that can confirm the speed calculated by the Sentinel Marbles. In the same manner, magnetometer readings from several marbles can be sampled and sent off to Fire Control for a further confirmation of speed by using complex algorithms based on real signature data.

### OBJECTS OF THE INVENTION

It is therefore the object of the invention to provide a method and apparatus to use for protecting any type of ship, but especially capital ships from attack by torpedoes, by supplying the ship's Fire Control indirect, rough information from Monitor Marbles (FIG. 1) about the torpedo speed, depth and position. Fire Control uses this raw data to determine when and where the torpedo will impact the ship or when and where the torpedo will cross the keel, as the case may be. Fire Control calculates these times and locations, and controls the anti-torpedo countermeasures and equipment for capturing or neutralizing a single torpedo or a salvo. Capture Curtains and their various automated equipment to either capture the torpedo by the method of this inventor's pending patents^{3,4}, or by the method of the provisional patent application of the same date as this instant application⁴, or supercavitating countermeasure missiles either now in the lab or currently being tested⁵.

Another object of the invention is a method and apparatus that uses Sentinel Marbles to detect and accept all necessary signature information about the torpedoes at some distance from the targeted ship. This information is transmitted to Fire Control for use of the Monitor Marbles closer to the ship, and prepares the launch of the marble swarm with the sector size depending on the track and torpedo information received.

Another object of the invention is a method and apparatus that can be used to detect and track a conventional, quiet submarine before it can slip away. For this purpose, the Sentinel Marble (FIG. 2) with its superior sonar, processing capability and transmission strength, will be launched by a helicopter within the area most likely to contain an enemy submarine. As the sub sneaks away in any direction, the marbles transmit data to Fire Control, and the helicopter can continue launching fewer marbles but in the continually calculated, smaller most-likely area. This continues until the sub descends below some layer that will hide it. However, the marbles become silent to the sub so it will never know when it is safe to ascend again or even when it can safely leave the area. To decrease surface noise in rough seas, a version of the Sentinel Marble can be tethered to a small weighted ball that keeps the antenna upright and out of the water (FIG. 3). For Sentinel Marbles that follow a submarine down and maintain continuous tracking for some interval, the tether is severed and the marble slowly sinks. One-way communication to the surface marbles is via sonar pinging.

Another object of the invention is to be release a special type of Sentinel Marbles with ultrasensitive magnetometers in front of a mine sweeper or between a pair of minesweepers so that the sensors can detect mines that are composed of enough iron (i.e. steel), and send warning signals to an onboard control device. Since high range magnetometers are now small enough for weak portable phones to use as a detector, the built-in devices will be able to detect and warn of the proximity of a sea mine) Mines are relatively inexpensive, but just the same are precious and used where enemy ships are to be expected. For this reason, the minesweepers would be able to launch numerous Sentinel Marbles to find the mine and warn the monitors of the detection of a possible mine.

### BRIEF DESCRIPTION OF THE DRAWINGS

The Monitor Marbles and the Sentinel Marbles are identical in size. In FIGS. 1 and 2, the size and placement of electronics, mechanical elements, batteries, etc. are quite similar but arbitrarily shown in the figures; in production, they will be positioned for equipment safety during launch and for reliability in the seawater. Heavy elements are placed opposite the antenna, ensuring that it always reaches above the surface for transmissions. The sonar sensors are not identical, and they may be molded into the ball instead of using adhesive as shown in FIGS. 1, 2 and 3, or they may be simply welded onto the inner ball surface, e.g. as in FIG. 1. No electrical wiring, radio frequency or microwave paths, etc. are shown in the figures. The waterline (1) is shown only in FIGS. 1 and 3.

The drawings in detail:

FIG. 1 represents the Monitor Marble in the water clearly showing the plastic marble (2). The ultra-lightweight antenna (3) is shown bobbing on the surface, not yet completely extended by its spring. Its perforated seal (9) is shown broken, and its main water seal (10) is also shown. A separate shaft for isolating the antenna from the other elements is shown, but by sealing the electronics and wiring, an antenna separation may not be necessary considering the short lifespan of this type of marble. The circuit board with electronic elements CPU, memory and special analog circuitry, common for both types of marbles, is shown in FIG. 2 but not in FIG. 1. The sonar (5) is shown as slightly smaller than the dual sonars of the Sentinel Marbles. A relatively small battery (4) is sufficient for the short tasks of these marbles. A self-destruction device (6) is executed via software.

FIG. 2 shows the Sentinel Marble. Its stereo-sonar (7) is shown as larger and more refined for its task of determining the torpedo signature and for electronically following an escaping submarine. The pre-calculations require the same powerful CPU as the Monitor Marbles; this data reduction allows for a shorter transmission to Fire Control, where every millisecond counts. This computing power is also required for re-transmission requests by Fire Control or requests for more data. Since the antenna is identical, it is not shown again in FIG. 2. The circuit board (8) is shown stylized, not as it will be after detailed design. The large battery (11) is required for executing all tasks.

FIG. 3: The Sentinel Marble for tracking silent submarines shows the float (14) containing the antenna, a heavy battery (11) to keep the antenna upright, and the tether (15) with integrated wiring to the antenna; wiring is not shown. The simple tether release mechanism is not shown. The interior, heavy electronic elements shown in FIG. 2 to keep the marble upright and submerged are not shown here since the Sentinel Marbles are identical except for task differences and its extra weight to allow it to slowly sink on command To indicate that the Sentinel Marble is almost identical to the Sentinel Marble of FIG. 2, it is marked (16).

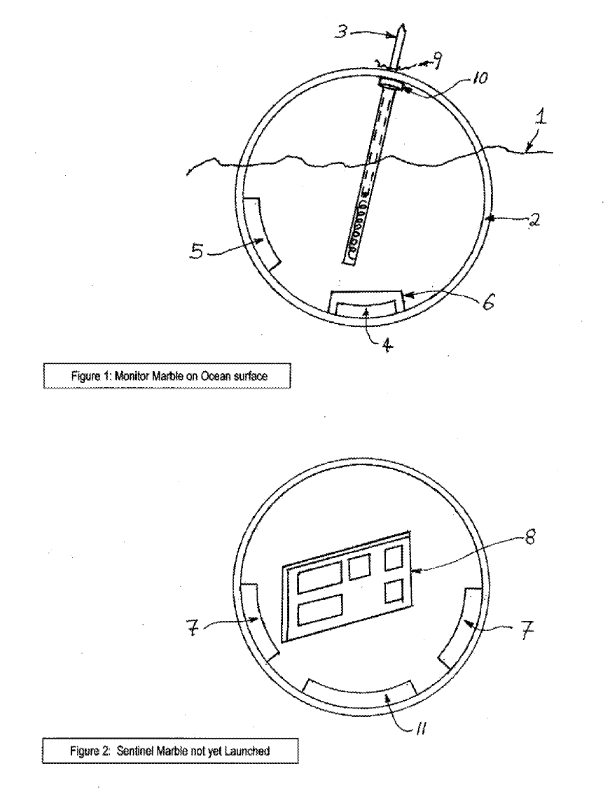

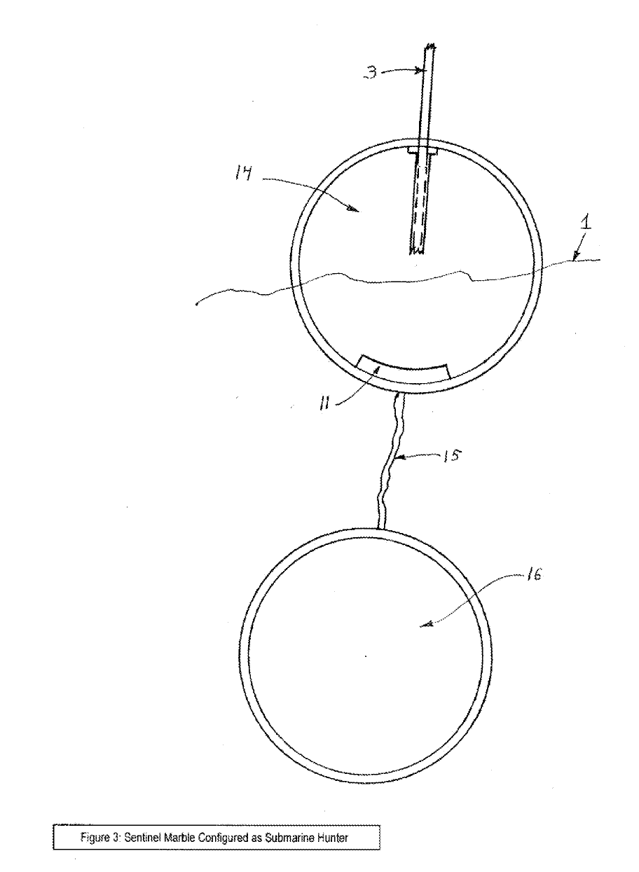

### REFERENCES

1 Cordell, Steve: Soft-Kill Capture of the Supercavitating Torpedo U.S. Naval Institute Proceedings Nov. 2008 p. 74-76
2 Cordell, Steve: “Capital Ship Defense from Supercavitating Torpedoes & Stealthy Surface/Underwater Threats” submitted 18 Jan. 2010 to U.S. Naval Institute Proceedings—not published
3 Cordell, Steve: U.S. patent Pending “Process and Apparatus for Protecting Capital Ships from Torpedoes, Sea-Skimming Weapons and Missiles patent application 17 May 2012 (Abandoned) Submitted U.S. Naval Institute Proceedings July 2013
4 Cordell, Steve: U.S. patent Pending U.S. patent Pending “Process and Apparatus for Ship Protection from Magnetic-Detonated Torpedoes Provisional Patent Application 17 Jul. 2012

What is claimed is:

1. A method, using Sentinel Marbles as specified in the specification, for timely and roughly determining the speed, depth, path, size, magnetic characteristics, noise signatures and other, currently unknown characteristics of an incoming torpedo comprising the steps of:
determining the torpedo's rough speed, depth, path and type from own-ship Fire Control and its own sonar, from sonar of accompanying ships', submarines, or helicopters, and
via Fire Control determining the optimum countermeasures using the apparatus of the invention that are the specified Sentinel Marbles, then determining the optimum targeting sector for the marbles, remotely programming the marbles while they are in the launcher or after launching, and
launching the optimum number of marbles as a swarm within a sector encompassing the path of the torpedo, marbles using final firmware entering from Fire Control, causing the Sentinels to execute opening sequences, involving turning on all elements of marbles and executing physical tasks of releasing and/or employing the antenna, radio transceiver, sonar and all sensors within said marble, and
communicating with Fire Control, working with said Sentinel Marbles, each of which is constantly monitoring the torpedo after initially detecting it, making all calculations possible and transferring the data to Fire Control, and
it is monitoring the command and data transferring from Fire Control, it is carrying out the input commands, and after Fire Control orders shutting down its monitoring, executing erasing and scrubbing its database begins.

2. A method, using Monitor Marbles as specified in the Specification, for timely and precisely determining the speed, depth, path, magnetic and noise signatures and other currently unknown characteristics of an incoming torpedo, each Monitor Marble in a swarm executes the steps of:
sampling magnetometer values of the torpedo beginning with the initial detection of the torpedo and ceasing after the torpedo is no longer in the area, and the marbles that collected the data are now transferring the raw, time-stamped data to Fire Control, and
at the same time, each marble in the swarm, having been assigned by Fire Control at least one other task, is collecting noise signatures, or depth data, length of torpedo based on sonar returns, location based on GPS, and
then transferring collected data to Fire Control.

3. The first of two auxiliary methods, which is continuously monitoring the location of a quiet submarine that has already been detected by a helicopter comprising the steps of:
updating Fire Control from the helicopter with the coordinates of the detected submarine, launching a wide swarm of Sentinel Marbles using the detection coordinates as the initial center of the marble swarm, preparing for launching the next marble swarm and
launching it on command from Fire Control using the method for the initial swarm launch, and
repeating the last step as often as required by Fire Control, and
The second of two auxiliary methods, which is continuously monitoring a given seaway path from one or two boats for sea mines, comprising the steps of:
launching a small swarm of Sentinel Marbles on the selected search path safely in front of or on the side of the boat in the usual Navy searching manner, or in the path of boats in side-to-side tandem formation, and
monitoring the magnetometers locally on the boats for iron detection that possibly indicates detection of a sea mine.
